(19) United States
(12) Patent Application Publication
(10) Pub. No.: US 2026/0019970 A1
(43) Pub. Date: Jan. 15, 2026

(54) NETWORK CONNECTIVITY BASED ON TIMING ADVANCE IN A TELECOMMUNOICATIONS NETWORK

(71) Applicant: T-Mobile USA, Inc., Bellevue, WA (US)

(72) Inventors: Krunal Modasiya, Herndon, VA (US); Mohd Khalil B Abu Baker, Herndon, VA (US); Samuel Wyman, Herndon, VA (US)

(21) Appl. No.: 18/773,170

(22) Filed: Jul. 15, 2024

(51) Int. Cl. H04W 56/00; H04W 16/28; H04W 36/24

(52) U.S. Cl. CPC H04W 56/0045; H04W 16/28; H04W 36/24

(57) ABSTRACT

Techniques for managing a communication session for user equipment (UE) based on a timing advance parameter are described herein. A telecommunications system can implement a computing device to detect a timing advance parameter in a message from the UE and compare the timing advance parameter to a pre-determined threshold. The computing device can generate the pre-determined threshold for a particular network element (e.g., a base station) and further determine whether or not to adjust a setting, such as a tilt angle, of the network element based on the comparing. The computing device can optimize pre-determined thresholds for various network elements to improve network efficiency of each network element including reducing a number of UEs receiving service from a further network element when a relatively closer network element is available.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example device can connect to a telecommunications system that includes an example access management system to implement the techniques described herein.

FIG. 2 depicts an example system architecture for a fifth generation (5G) telecommunication network.

FIG. 3 depicts another example network environment in which an example user equipment can connect to a telecommunication system that includes an example access management system to implement the techniques described herein.

FIG. 4 depicts a flowchart of an example process for determining communication channels by an example access management system.

FIG. 5 depicts an example system architecture for a user equipment.

### DETAILED DESCRIPTION

This application relates to techniques for determining access for a device to a telecommunications network. The techniques can include a system controlling access of the device (e.g., a user equipment (UE)) to a network element (e.g., a base station, a transceiver, or the like) to cause the device to receive service from a closest available network element. The system can, for example, detect that the device is being served (e.g., exchanging data) by a base station that is farther from the device than another available base station, and determine an action (e.g., a setting or a parameter of the base station) to cause the device to receive service from the other, closer base station. The techniques can include, for example, identifying a UE that is “overshooting” to a first network element and causing the UE to change from using the first network at a first time to using a second network (to exchange data) at a second time. By controlling access of the device to various network elements using the techniques described herein, network capacity, latency, etc. of a telecommunications system can be improved.

The techniques described herein can include a telecommunications system implementing a computing device and/or an access management system to determine a network element for exchanging data with a device. In various examples, the computing device can implement an access management component to detect a device that is over a threshold distance from a network element and adjust a setting or parameter (e.g., a tilt angle) of the network element to cause the device to connect to another network element that is closer to the device. The access management component can, for example, detect information in a message between the device and the network element (e.g., a call between the device and another device), and use the information to determine a distance between the device and the network element. In some examples, the detected information can include a timing parameter sent from the device to the network element, and the computing device can determine a location of the UE relative to the network element based on the timing parameter. Based on the distance of the UE from the network element, the computing device can determine whether to take a first action (e.g., to continue service from the first network element) or a second action (e.g., change a mechanical and/or electronic tilt angle or other setting of the first network element). Additional discussion of determining a distance between a device and various network elements, and various potential actions, can be found throughout this disclosure including in the figures below.

In some examples, the network element can represent, for example, a base station (gNB), a transceiver, an antennae, a relay point, an access point, a serving node, a computing device (e.g., a server), or other entity of the telecommunications network. The techniques described herein can be used to control which network elements are accessed by a device based on a distance between the device and the network element. For instance, the access management component can optimize settings or parameters for one or more network elements (e.g., adjust title angles for various network elements) to improve relatability, latency, etc. associated with a communication by the device.

By way of example and not limitation, the computing device can detect whether a UE is “overshooting” to a first base station and determine an action to cause the UE to exchange data in the future with a second base station. The computing device may, for instance, determine a distance of the UE to a network element based at least in part on a timing parameter included in a message, communication, etc. between the UE and the network element at a previous time. Different timing parameters may be associated with different frequencies, and the techniques can include comparing the timing parameter for a particular device to a pre-determined timing parameter threshold. Devices associated with a timing parameter that meets or exceeds the pre-determined timing parameter threshold (e.g., for a frequency) can exchange data with another network element by modifying operation of the network element to “drop” the device.

In some examples, the computing device can implement a model or component to monitor, intercept, or otherwise detect activity (a data exchange) between a device and a network element over time. For example, the computing device can detect changes in timing parameters used by the device at a particular time to account for the device’s potential change of location over time. For example, the computing device can detect changes in the location of a UE over time by detecting a timing parameter in data exchanges between the UE and the network element. Timing parameters (and frequencies associated with therewith) can be compared to a respective threshold, and a timing parameter below the threshold for a particular frequency can cause a first action (e.g., no action, continue to serve UE) and a timing parameter that meets or exceeds the threshold for the particular frequency can cause a second action (e.g., change a tilt angle of the network element). Other actions are may also or instead be implemented depending on examples, as discussed herein.

In various examples, the computing device can be centrally located (e.g., separate from a network element) and/or located at one or more of the network elements. Regardless of location, the computing device can optimize settings, thresholds, and the like for various network elements to improve efficiency of available network elements to provide service to the greatest number of devices.

The access management system can, in various examples, generate pre-determined thresholds for a particular network element (e.g., a base station) in which each pre-determined threshold corresponds to a respective frequency or frequency range. The access management system can optimize pre-determined thresholds for various network elements over time by analyzing characteristics of the network element and/or devices associated with the network element. For example, a distance threshold, a timing parameter threshold (e.g., a timing advance parameter threshold), or the like can be determined periodically by a model or component to improve accuracy of an output by the access management system.

The access techniques described herein can improve a computing device and/or network in a variety of ways. Quality of service, network bandwidth, can be improved by managing access to a device with consideration to a distance of the device using a timing parameter. For instance, a UE can receive service from a closer available network element based on determining that the UE is overshooting to a network element. The access techniques may also improve the telecommunications use of available computational resources (e.g., network elements, processing resources, memory resources, and the like). For example, by reducing a number of overshooting devices in a telecommunications network, available network elements can serve a greater number of devices with a same amount of available computational resources.

Though some examples are described in relation to a computing device, in various examples one or more computing devices, UEs, networks, or other entities may perform or otherwise be associated with the techniques described herein. In various examples, the device may be configured with instructions to implement the techniques described herein. For example, the device can be configured with the instructions to cause the device to use a particular network element for transmitting a first message to a particular server, base station, or network (e.g., a core network).

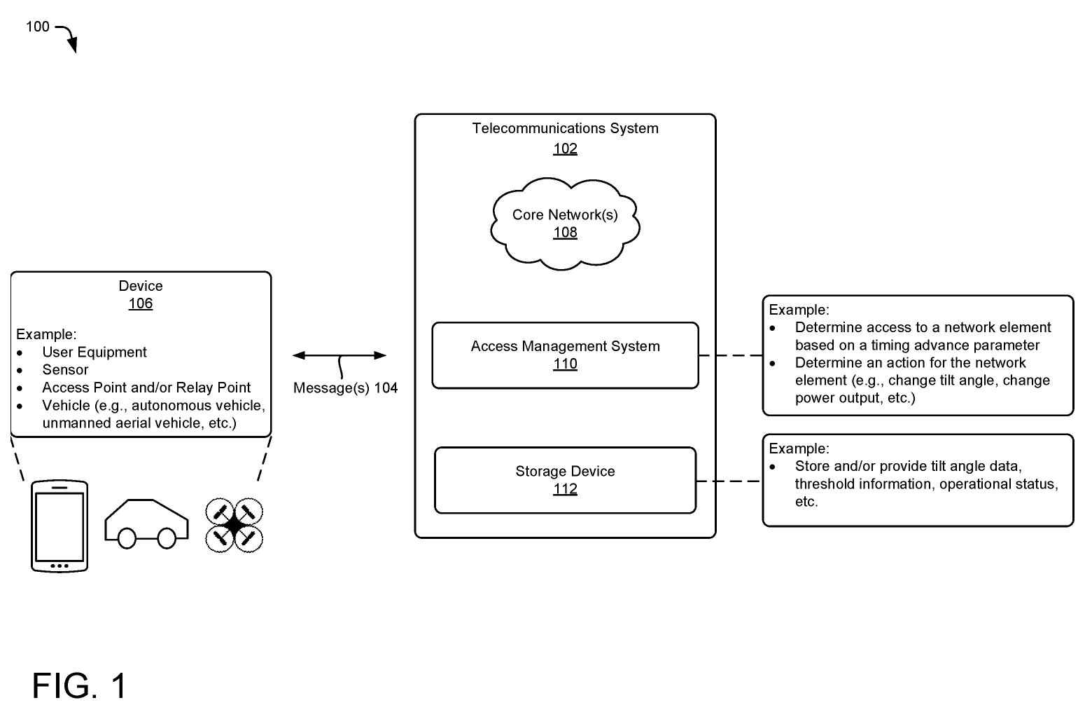

FIG. 1 depicts an example network environment 100 in which an example device can connect to a telecommunications system that includes an example access management system to implement the techniques described herein. For example, a telecommunications system 102 can exchange one or more messages 104 (may also be referred to as the message 104 or the message(s) 104) with a device 106. As shown in FIG. 1, the telecommunications system 102 includes one or more core network(s) 108 for exchanging data (may also be referred to as the core network 108 or the core network(s) 108), an access management system 110, and a storage device 112. The access management system 110 can be configured to determine a communication channel for the device 106. In various examples, the device 106 can connect to a network element to exchange data using the communication channel.

The message 104 can represent a communication or an exchange of data between the device 106 and the core network 108, such as a request from the device 106 to place a call, access a service, or otherwise connect to the telecommunications system 102. The message 104 may, for example, represent a communication between the device 106 (e.g., a first UE) and a second UE. In some examples, the message 104 can include information associated with the device 106 such as a timing parameter, frequency information, network information, etc. For example, the timing parameter can represent a timing advance parameter usable to control timing of data exchanged (e.g., the message 104) with a network element (e.g., a base station, etc.). The frequency information can include, for example, a previous frequency, a current frequency, or a requested frequency for the device 106 to exchange data.

The device 106 may represent any device that can wirelessly connect to the telecommunication network, and in some examples may include a mobile phone, a sensor, a personal digital assistant (PDA), a personal computer (PC) such as a laptop, desktop, or workstation, a media player, a tablet, a gaming device, an access point, a relay point, a smart watch, a hotspot, a Machine to Machine device (M2M), a vehicle (e.g., an autonomous vehicle, an unmanned aerial vehicle, airplane, boat, etc.), an Internet of Things (IoT) device, or any other type of computing or communication device.

The core network 108 can represent a 5G network in various examples, though other core network types may also be used (e.g., past or future generation networks such as a sixth generation (6G) network).

The access management system 110 may represent firmware, hardware and/or software that generates, assigns, selects, or otherwise determines a communication channel(s) for the device 106. The access management system 110 may, in some examples, provide functionality to determine access to a network element based at least in part on the information in the message 104 (e.g., the timing parameter, the frequency information, etc.). For example, the access management system 110 can select an available network element to exchange data with the device 106 based on comparing at least some of the information in the message 104 to a pre-determined threshold. A network element can represent, for example, a base station (gNB), a transceiver, an antennae, a relay point, an access point, a serving node, a computing device (e.g., a server), just to name a few.

In some examples, the access management system 110 can determine that the information includes a timing advance parameter and optionally compare the timing advance parameter to a timing threshold. The timing threshold can, for example, represent a pre-determined value output by a model, component, and/or a user (e.g., an engineer). Based on the comparison to the timing threshold, the access management system 110 can determine an action for the network element (currently serving the device 106). An action may include, for instance, sending a communication from the access management system 110 to the network element to cause the network element to change a title angle (e.g., mechanical and/or electronic), change power output, or the like.

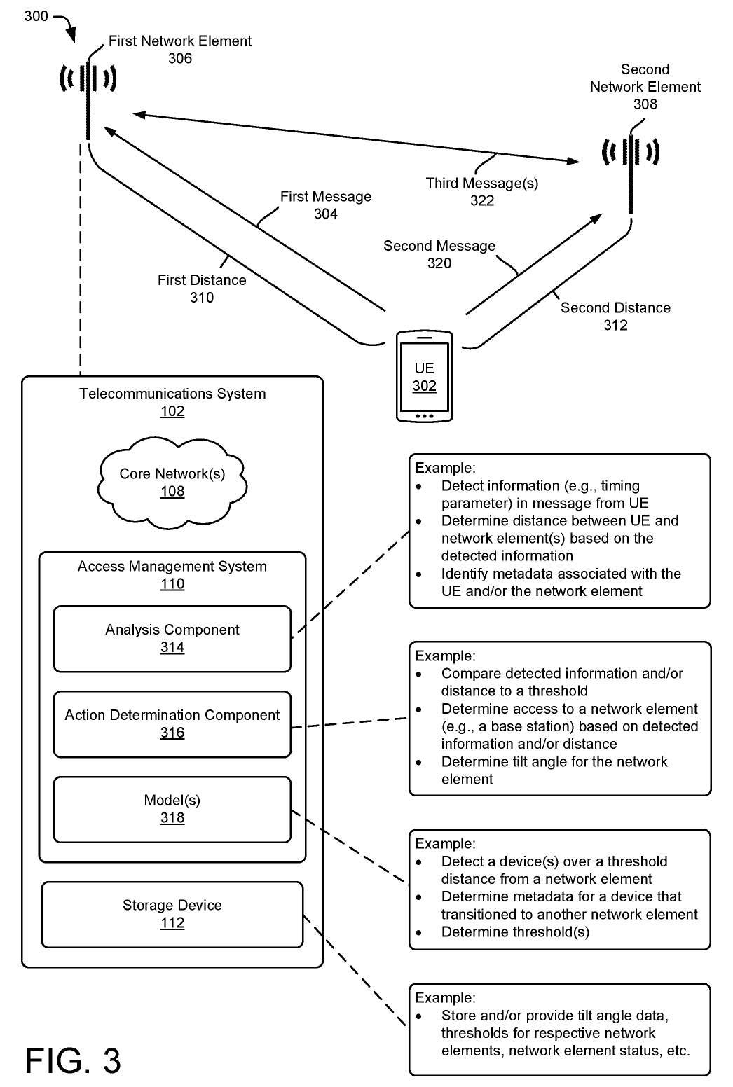

In various examples, the access management system 110 can send instructions to the network element to change a parameter, setting, etc. of the network element. In some examples, the change in parameter, setting, etc. can cause the network element to no longer serve the device 106 in place of another network element (e.g., a second network element that is closer to the device than the network element). Further discussion of the access management system 110 can be found throughout this disclosure including in FIG. 3 below.

The storage device 112 can provide functionality to store and/or provide data associated with a network element or the device 106 usable for providing the techniques described herein. For example, the storage device 112 can receive network information from various network elements including but not limited to previous and/or current tilt angle data, power output data, etc. In some examples, the storage device 112 can provide network information (e.g., availability status, range, power availability, etc.) to the access management system 110 to indicate which network elements are available (e.g., to prevent moving the device 106 to a closer network element that lacks the resources to provide service to the device 106). The access management system 110 (or component thereof) may, for example, exchange data with the storage device 112 (e.g., a memory, a database, etc.) to implement the access techniques described herein.

In various examples, the storage device 118 can represent a Unified Data Management (UDM) to manage user data and/or an Authentication Server Function (AUSF) to manage authorization for the device 106 (e.g., in the 5G system shown). However, in examples when the core network 108 is different from 5G, such as 4G, the storage device 112 can represent a Home Subscriber Server (HSS). Thus, the storage device 112 can represent various subscription management entities depending upon a type of the core network 108 used to employ the techniques.

In some examples, the access management system 110 can determine metadata associated with the device 106 and/or the network element describing a reason or conditions for transferring the device 106 from a first network element to a second network element. In various examples, the access management system 110 can output metadata describing particular conditions (e.g., tilt angle, power output, distance data, timing parameter, weather conditions, time of day, etc.) associated with a transfer of network elements. Additionally, or alternatively, the management system 110 can output metadata representing predicted activity associated with the device 106 in the future (e.g., likely distances at which a transfer is to take place, etc.). In various examples, the access management system 110 can determine a communication channel for the device 106 based at least in part on the metadata.

In various examples, the access management system 110 can implement one or more models that may be representative of machine learned models, non-machine learning models, or a combination thereof. As described herein, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In various examples, output data from the access management system 110 can be stored in the storage device 112 for access at a later time. For example, the storage device 112 can receive data representing previous output data by the access management system 110 for storage and make such data available to a component, device, etc. for processing at a later time.

To implement the techniques described herein, in various examples the telecommunications system 102 and/or the access management system 110 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 102 (e.g., a 5G system) can represent functionality to provide a communication channel for the device 106 and can include one or more radio access networks (RANs), as well as one or more core networks linked to the RANs. For instance, the device 106 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 102 is compatible to operate with other radio technologies including those of other service providers. Accordingly, the message(s) 104 associated with the device 106 may originate with another service provider (e.g., a third-party) and be processed by the access management system 110 independent of the technolog(ies) or core network associated with the service provider.

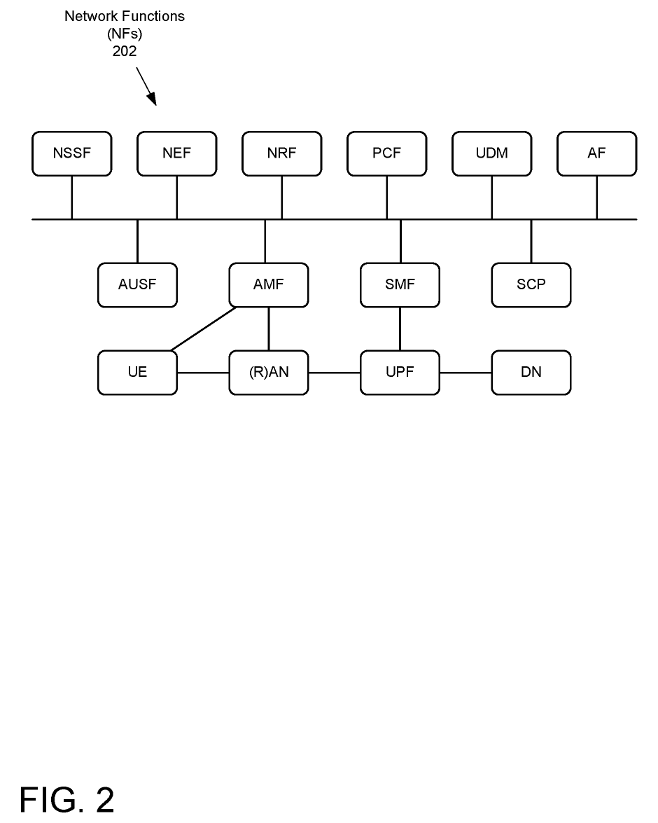

In some examples, the core network 108 can represent a service-based architecture that includes multiple types of network functions that process control plane data and/or user plane data to implement services for the device 106. In some examples, the services comprise rich communication services (RCS), a VoNR service, a ViNR service, and the like which may include a text, a data file transfer, an image, a video, or a combination thereof. The network functions of the core network 108 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 108 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 108 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 108 can, in some examples, determine a connection between an IMS that manages a communication session for the device 106, including sessions for short messaging, voice calls, video calls, and/or other types of communications. For example, the device 106 and the IMS of the telecommunications system 102 can exchange Session Initiation Protocol (SIP) messages to set up and manage individual communication sessions.

Though some examples in FIG. 1 and elsewhere are described in association with a 5G telecommunication system, the techniques described herein can be used in other telecommunication system types include past generation and/or future generation telecommunication systems.

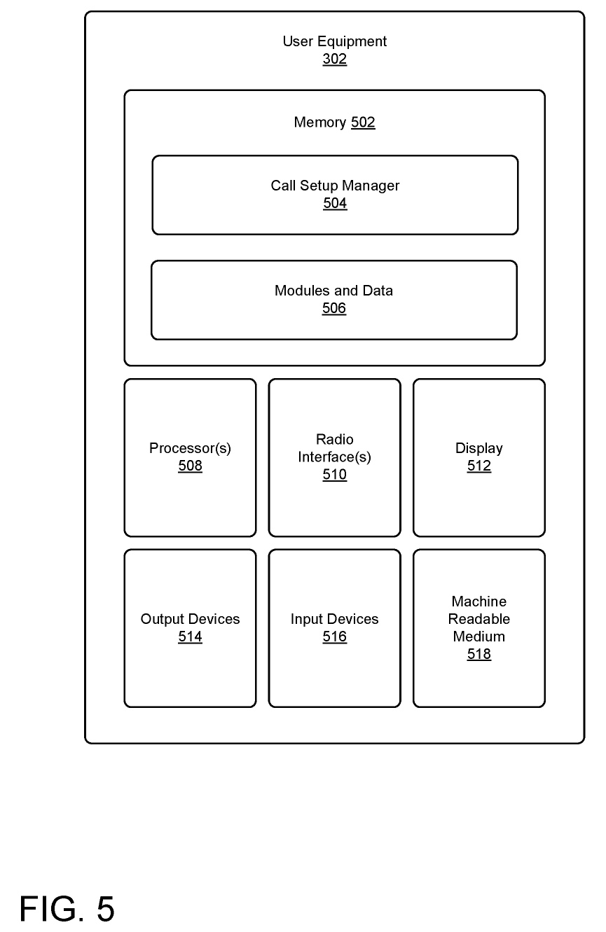

FIG. 3 depicts another example network environment 300 in which an example user equipment can connect to a telecommunication system that includes an example access management system to implement the techniques described herein. For example, a UE 302 can access the telecommunications system 102 of FIG. 1 by sending a first message 304 to a first network element 306. The UE 302 can, in some examples, include at least the functionality of the device 106 of FIG. 1. The access management system 110 can operate as a server, a network element, or other computing device that accesses the first message 304 and determines whether to establish a communication channel with the UE 302 using the first network element 306 or a second network element 308 based on the information in the message 304. An example architecture for the UE 302 is illustrated in greater detail in FIG. 5.

As shown in FIG. 3, the first network element 306 is a first distance 310 from the UE 302 and the second network element 308 is a second distance 312 from the UE 302. Generally, the first distance 310 is greater than the second distance 312 to represent an example in which the UE 302 is associated with the first network element 306 at a first time and is transferred to the second network element 308 to improve quality of service, etc. for the UE 302. FIG. 3 further depicts the access management system 110 comprising an analysis component 314, an action determination component 316, and one or more models 318 to implement the techniques described herein.

The analysis component 314 can, for example, detect information in the first message 304 including but not limited to timing information, frequency information, etc. The timing information can include a timing variance parameter for determining the timing for sending subsequent data to the UE 302. In various examples, the analysis component 314 can determine access to a network element based on the detected information. In some examples, the analysis component can determine a distance between the UE 302 and the first network element 306 based at least in part on applying a mathematical algorithm to the timing variance parameter.

The first message 304 can include frequency information associated with a current communication channel used for transmitting the first message 304, and the distance between the UE 302 and the first network element 306 can further depend on the frequency information. For example, the analysis component 314 can use the timing variance parameter to determine the distance using fewer computational resources than alternative techniques for determining the distance thereby freeing up available computational resources. Further, determining a distance based on the timing variance parameter as described herein can be done in less time compared to relying on location information from a global positioning system or other location system.

In some examples, the analysis component 314 can identify or otherwise determine metadata associated with the UE 302, the first network element 306, or the second network element 308. For example, characteristics of the first network element 306 and/or the second network element 308 at a time that the access management system 110 determines to establish a second message 320 using a second communication channel to the second network element 308. The characteristics can represent a tilt angle, power output, distance, etc. associated with the UE 302, the first network element 306 and/or the second network element 308 before, during, and/or after determining to use the second network element.

In various examples, the first network element 306 can represent a first base station that is further from the UE 302 than a second base station represented by the second network element 308, in the access management system 110 can implement one or more of the analysis component 314, the action determination component 316, or the model(s) 318 to cause the UE 302 to receive service via the second message 320 based on the first distance 310 meeting or exceeding a distance threshold. For example, the analysis component 314 can determine the first distance 310 based on the timing advance parameter in the first message 304 and determine that the distance meets or exceeds the distance threshold.

The action determination component 316 can represent functionality to determine an action for one or more network elements or other entity of the telecommunication system 102. For example, the action determination component 316 can determine a first action such as adjusting a tilt angle and/or reducing power output of the first network element 306 to cause the UE 302 to exchange data with the second network element 308 (instead of the first network element 306) based at least in part on the distance meeting or exceeding the distance threshold.

In some examples, the action determination component 316 can compare at least some of the detected information such as a timing advance parameter to a timing advance parameter threshold. One or more of the models 318 can, for example, determine the timing advance parameter thresholds for various frequencies at a time prior to receiving the first message 304. In various examples, the one or more models 318 can determine a timing advance parameter threshold based on metadata from the storage device 112 describing characteristics of a respective network elements, devices, etc. during one or more previous action determinations.

In various examples, the action determination component 316 can compare a distance determination from the analysis component 314 to a distance threshold and determine the action based at least in part on the comparison. For example, the first distance 310 can be determined from a timing parameter in the first message 304 and compared with maximum distances for various frequencies that may potentially reach the UE 302. The maximum distances for the various frequencies of respective network elements can be determined at a previous time to identify occurrences when the UE 302 is overshooting or otherwise able to receive service from a relatively closer network element, the second network element 308.

In some examples, the action determination component 316 can output parameters or settings for the first network element 306 to cause the UE 302 to receive service from the second network element 308. For instance, the action determination component 316 can determine tilt angle information for the first network element 306 which may include a mechanical tilt angle and/or an electronic tilt angle, and transmit the tilt angle information to the first network element 306. The action determination component 316 may also or instead determine parameter settings to modify power output, a frequency, or other characteristics of the first network element 306.

In various examples, one or more of the models 318 can be implemented to determine metadata for the UE 302, the first network element 306, and/or the second network element 308 describing occurrences in which the UE 302 transitioned from receiving service from the first network element 306 to receiving service from the second network element 308. In some examples, the metadata may be used as training data for a machine learned model of the models 318 that is trained to output a distance threshold, a timing variance parameter threshold, and/or the like. In some examples, the machine learned model may be trained to detect devices over a threshold distance from a network element by monitoring timing information included in a message between the UE 302 and a currently network element.

The access management system 110 can receive one or more third messages 322 representing information exchanged between the first network element 306 and the second network element 308. For example, first network element 306 and the second network element 308 can exchange network information including a status of whether or not a respective network element is available to provide a communication channel to the UE 302. In this way, the access management system 110 can verify that the second network element 308 status (e.g., an operational status “yes” or “no”) indicates that it is available prior to transitioning the UE 302 to the second network element 308.

Note that the first message 304, the second message 320, and the third message(s) 322 denote different instances of a message and do not reflect a temporal relationship. For example, one or more of the first message 304, the second message 320, and/or the third message(s) 322 may be excluded in some examples or otherwise received by the access management system 110 in any order relative to one another. Additionally or alternatively, the first message 304, the second message 320, and/or the third message(s) 322 may be received by the access management system 110 at substantially simultaneously a same time.

By way of example and not limitation, the analysis component 314 can determine a frequency associated with the first message 304, and select the pre-determined timing advance threshold from a set of pre-determined thresholds based at least in part on the frequency associated with the first message 304. For example, the frequency of the first communication channel associated with the first message 304 may be considered by the analysis component 314 to identify the predetermined timing advance threshold for the UE 302 at a particular time.

Though the analysis component 314, the action determination component 316, and the one or more models 318 are illustrated in FIG. 3 individually, it is understood that the analysis component 314, the action determination component 316, and the one or more models 318 (or functionality provided therefrom) may be directly coupled to and/or integrated into a single component or computing device (including in some examples the UE 302). In some examples, functionality associated with the analysis component 314, the action determination component 316, and the one or more models 318 may be directly coupled to and/or integrated into the device 106 of FIG. 1 and/or the UE 302 of FIG. 3.

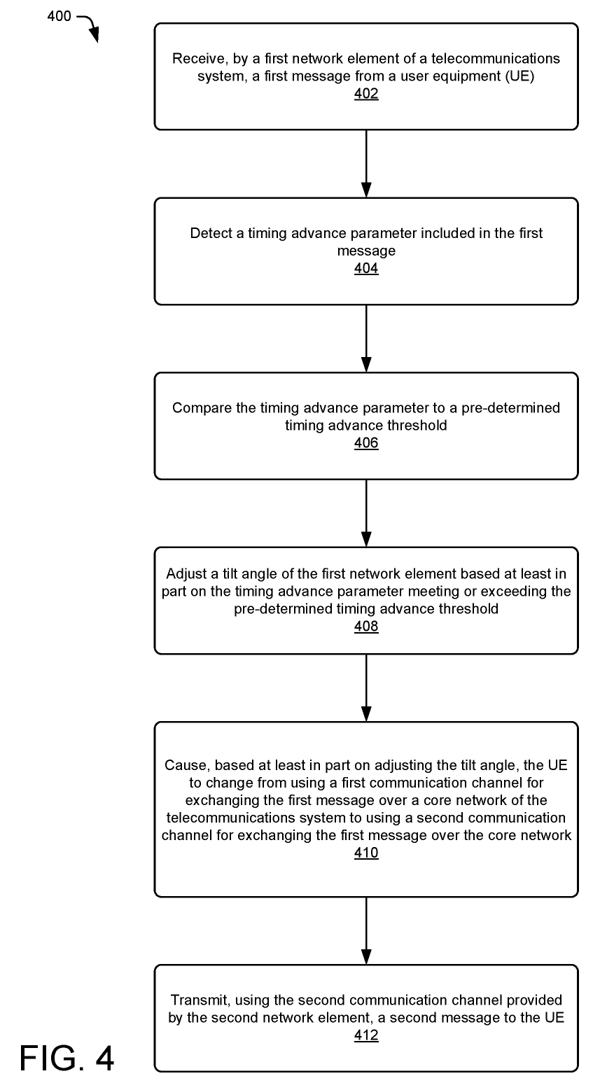

FIG. 4 depicts a flowchart of an example process 400 for determining one or more communication channels by an example access management system. Some or all of the process 400 may be performed by one or more components in FIGS. 1-3, as described herein. For example, some or all of process 400 may be performed by the access management system 110 of FIG. 1. In some examples, a communication channel can be determined for a UE that is “overshooting” to receive service from a network element while another, closer network element is available to provide improved service to the UE.

At operation 402, the process may include receiving, by a first network element of a telecommunications system, a first message from a user equipment (UE). For example, the first network element 306 can receive a first message 304 from the UE 302 using a core network (e.g., the core network(s) 108). In some examples, the operation 402 may include the access management system 110 receiving message data from the device 106 to exchange data (e.g., request a communication session with another UE, maintain an existing communication session, etc.). The access management system 110 may, for instance, receive a message (e.g., the message 104) from the device 106 to establish or maintain a voice, video, and/or text communication session.

In some examples, the first network element can represent a first base station that provides service to the UE 302 and is located further from the UE 302 than another available network element (e.g., the second network element 308). The message from the UE 302 can, for example, include timing information, frequency information, or other characteristics of the UE 302 usable for determining a communication channel.

At operation 404, the process may include detecting a timing advance parameter included in the first message. For instance, the access management system 110 can identify, detect, or otherwise determine a timing variance parameter included in the message 104 and/or the first message 304. In examples when the UE 302 changes position over time, the access management system 110 can analyze new messages exchanged with the UE 302 to detect a timing variance parameter associated with one or more messages at different times.

At operation 406, the process may include comparing the timing advance parameter to a pre-determined timing advance threshold. In some examples, the operation 406 may include the access management system 110 accessing a set of pre-determined threshold from the storage device 112, such as pre-determined timing advance thresholds for various frequencies operable by the first network element 306 and the UE 302. The access management system 110 can, for example, determine a frequency used by the UE 302 to transmit the message, and identify a pre-determined timing advance threshold for the particular frequency used.

In some examples, the operation 406 may include the access management system 110 generating the pre-determined timing advance threshold based at least in part on analyzing metadata associated with previous “handoffs” from the first network element to a second, closer network element. The storage device 112 can provide metadata for use in determining pre-determined timing advance thresholds specific for various network elements. In some examples, the access management system 110 can implement the model(s) 318 to determine a first pre-determined timing advance threshold for the first network element based on a first set of criteria and a second pre-determined timing advance threshold for the second network element based on a second set of criteria. The first set of criteria and/or the second set of criteria can include metadata specific for a particular network element, among other information.

At operation 408, the process may include adjusting a tilt angle of the first network element based at least in part on the timing advance parameter meeting or exceeding the pre-determined timing advance threshold. In some examples, the operation 408 may include the access management system 110 outputting an instruction for transmitting to the first network element to cause a tile angle to change from a first configuration to a second configuration. The instruction output by the access management system 110 can, for example, include one or more settings or parameters for modifying a mechanical tilt angle and/or an electronic tilt angle of the first network element.

At operation 410, the process may include causing, based at least in part on adjusting the tilt angle, the UE to change from using a first communication channel for exchanging the first message over a core network of the telecommunications system to using a second communication channel for exchanging the first message over the core network. For example, the access management system 110 can cause the first network element to no longer reach a location of the UE 302 by adjusting the tilt angle and instead use a different communication channel associated with the second network element. In various examples, the second communication channel provided by the second network element that is different from a first communication channel provided in association with the first network element.

At operation 412, the process may include transmitting, using the second communication channel provided by the second network element, a second message to the UE. For example, the UE 302 and the second network element can exchange data associated with the second message 320 using the second communication channel. Operation 412 may include, for instance, transmitting the second message based at least in part on adjusting a setting or a parameter of the first network element.

FIG. 5 depicts an example system architecture for the UE 302, in accordance with various examples. As shown, a UE 302 can have memory 502 storing a call setup manager 504, and other modules and data 506. A UE 302 can also comprise processor(s) 508, radio interfaces 510, a display 512, output devices 514, input devices 516, and/or a machine readable medium 518.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 302. Any such non-transitory computer-readable media may be part of the UE 302.

The call setup manager 504 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 506 can be utilized by the UE 302 to perform or enable performing any action taken by the UE 302. The modules and data 506 can include a UE platform, operating system, and applications, and data utilized by the platform, operating system, and applications.

In various examples, the processor(s) 508 can be a central processing unit (CPU), a graphics processing unit (GPU), or both CPU and GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing all computer applications stored in the memory 502, which can be associated with common types of volatile (RAM) and/or nonvolatile (ROM) memory.

The radio interfaces 510 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 510 can be compatible with multiple radio access technologies, such as 5G radio access technologies and 4G/LTE radio access technologies. Accordingly, the radio interfaces 510 can allow the UE 302 to connect to a 5G system and/or a 4G system (or other past or future system) as described herein.

The display 512 can be a liquid crystal display or any other type of display commonly used in UEs. For example, display 512 may be a touch-sensitive display screen, and can then also act as an input device or keypad, such as for providing a soft-key keyboard, navigation buttons, or any other type of interactive input. In some examples, the display 512 can represent a wearable device such as a headset for presenting and/or receiving data associated with a user. The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display. The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, that embodies any one or more of the methodologies or functions described herein. The instructions can also reside, completely or at least partially, within the memory 502, processor(s) 508, and/or radio interface(s) 510 during execution thereof by the UE 302. The memory 502 and the processor(s) 508 also can constitute machine readable media 518.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by a first network element of a telecommunications system, a first message from a user equipment (UE);
detecting a timing advance parameter included in the first message;
comparing the timing advance parameter to a pre-determined timing advance threshold;
adjusting a tilt angle of the first network element based at least in part on the timing advance parameter meeting or exceeding the pre-determined timing advance threshold;
causing, based at least in part on adjusting the tilt angle, the UE to change from using a first communication channel for exchanging the first message over a core network of the telecommunications system to using a second communication channel for exchanging the first message over the core network, the second communication channel provided by a second network element different from the first network element; and
transmitting, using the second communication channel provided by the second network element, a second message to the UE.

2. The method of claim 1, further comprising:
determining a frequency associated with the first message; and
selecting the pre-determined timing advance threshold from a set of pre-determined thresholds based at least in part on the frequency associated with the first message.

3. The method of claim 1, further comprising:
determining metadata associated with the first network element and the UE at a time period prior to causing the UE to change from using the first communication channel to using the second communication channel; and
determining whether to adjust the pre-determined timing advance threshold based at least in part on the metadata.

4. The method of claim 1, further comprising:
determining a distance between the first network element and the UE based at least in part on the timing advance parameter; and
determining that the distance between the first network element and the UE meets or exceeds a distance threshold;
wherein adjusting the tilt angle of the first network element is further based at least in part on determining that the distance between the first network element and the UE meeting or exceeding the distance threshold.

5. The method of claim 1, wherein adjusting the tilt angle of the first network element comprises modifying a mechanical tilt angle or an electronic tilt angle of the first network element from a first setting at a first time to a second setting at a second time.

6. The method of claim 1, wherein the first network element is a first base station and the second network element is a second base station, and the method further comprising:
receiving a third message indicating an operational status of the second base station, the third message received prior to the first message,
wherein adjusting the tilt angle of the first network element is further based at least in part on the operational status of the second base station.

7. A system comprising:
one or more processors; and
memory storing computer-executable instructions that, when executed by the one or more processors, cause the system to perform operations comprising:
receiving, by a first network element of a telecommunications system, a first message from a user equipment (UE);
detecting a timing advance parameter included in the first message;
comparing the timing advance parameter to a pre-determined timing advance threshold;
adjusting a tilt angle of the first network element based at least in part on the timing advance parameter meeting or exceeding the pre-determined timing advance threshold;
causing, based at least in part on adjusting the tilt angle, the UE to change from using a first communication channel for exchanging the first message over a core network of the telecommunications system to using a second communication channel for exchanging the first message over the core network, the second communication channel provided by a second network element different from the first network element; and
transmitting, using the second communication channel provided by the second network element, a second message to the UE.

8. The system of claim 7, the operations further comprising:
determining a frequency associated with the first message; and
selecting the pre-determined timing advance threshold from a set of pre-determined timing advance thresholds based at least in part on the frequency associated with the first message.

9. The system of claim 7, the operations further comprising:
determining metadata associated with the first network element and the UE at a time period prior to causing the UE to change from using the first communication channel to using the second communication channel; and
determining whether to adjust the pre-determined timing advance threshold based at least in part on the metadata.

10. The system of claim 7, the operations further comprising:
determining a distance between the first network element and the UE based at least in part on the timing advance parameter; and
determining that the distance between the first network element and the UE meets or exceeds a distance threshold;
wherein adjusting the tilt angle of the first network element is further based at least in part on determining that the distance between the first network element and the UE meeting or exceeding the distance threshold.

11. The system of claim 7, wherein adjusting the tilt angle of the first network element comprises modifying a mechanical tilt angle or an electronic tilt angle of the first network element from a first setting at a first time to a second setting at a second time.

12. The system of claim 7, wherein the first network element is a first base station and the second network element is a second base station, and the operations further comprising:
receiving a third message indicating an operational status of the second base station, the third message received prior to the first message,
wherein adjusting the tilt angle of the first network element is further based at least in part on the operational status of the second base station.

13. The system of claim 7, wherein the pre-determined timing advance threshold is a first pre-determined timing advance threshold the operations further comprising:
determining the first pre-determined timing advance threshold for the first network element based on a first set of criteria; and
determining a second pre-determined timing advance threshold for the second network element based on a second set of criteria.

14. The system of claim 7, the operations further comprising:
determining metadata associated with the first network element and the UE at a time period prior to causing the UE to change from using the first communication channel to using the second communication channel;
training a machine learned model to determine a set of timing advance thresholds for the first network element; and
transmitting the set of timing advance thresholds to the first network element for comparing to a subsequent timing advance parameter received from the UE at a later time.

15. The system of claim 7, the operations further comprising:
the first network element or the second network element represents one of: a base station, a transceiver, or an antennae.

16. One or more non-transitory computer-readable media storing instructions executable by one or more processors, wherein the instructions, when executed, cause the one or more processors to perform operations comprising:
receiving, by a first network element of a telecommunications system, a first message from a user equipment (UE);
detecting a timing advance parameter included in the first message;
comparing the timing advance parameter to a pre-determined timing advance threshold;
adjusting a tilt angle of the first network element based at least in part on the timing advance parameter meeting or exceeding the pre-determined timing advance threshold;
causing, based at least in part on adjusting the tilt angle, the UE to change from using a first communication channel for exchanging the first message over a core network of the telecommunications system to using a second communication channel for exchanging the first message over the core network, the second communication channel provided by a second network element different from the first network element; and
transmitting, using the second communication channel provided by the second network element, a second message to the UE.

17. The one or more non-transitory computer-readable media of claim 16, the operations further comprising:
determining a frequency associated with the first message; and
selecting the pre-determined timing advance threshold from a set of pre-determined thresholds based at least in part on the frequency associated with the first message.

18. The one or more non-transitory computer-readable media of claim 16, the operations further comprising:
determining metadata associated with the first network element and the UE at a time period prior to causing the UE to change from using the first communication channel to using the second communication channel; and
determining whether to adjust the pre-determined timing advance threshold based at least in part on the metadata.

19. The one or more non-transitory computer-readable media of claim 16, the operations further comprising:
determining a distance between the first network element and the UE based at least in part on the timing advance parameter; and
determining that the distance between the first network element and the UE meets or exceeds a distance threshold;
wherein adjusting the tilt angle of the first network element is further based at least in part on determining that the distance between the first network element and the UE meeting or exceeding the distance threshold.

20. The one or more non-transitory computer-readable media of claim 16, wherein adjusting the tilt angle of the first network element comprises modifying a mechanical tilt angle or an electronic tilt angle of the first network element from a first setting at a first time to a second setting at a second time.
